(19) United States
(12) Patent Application Publication
(10) Pub. No.: US 2018/0370014 A1
(43) Pub. Date: Dec. 27, 2018

(54) HAND-HELD POWER TOOL

(71) Applicant: Robert Bosch GmbH, Stuttgart (DE)

(72) Inventors: Heiko Roehm, Stuttgart (DE); Martin Kraus, Filderstadt (DE)

(21) Appl. No.: 16/006,934

(22) Filed: Jun. 13, 2018

(30) Foreign Application Priority Data
Jun. 22, 2017 (DE) 102017210467.8

(51) Int. Cl. B25F 5/02

(52) U.S. Cl. CPC B25F 5/02; B25B 21/00

(57) ABSTRACT

A hand-held power tool, in particular a combi drill, which includes a drive unit for transferring a working movement to an insertion tool, a machine housing that is designed in particular as a handle housing made of plastic, and an interface unit that is detachably fastenable to a rechargeable battery unit. The interface unit includes a retaining unit that is provided for holding the rechargeable battery unit in a fastened state connected to the hand-held power tool. It is provided that the retaining unit includes metal.

### CROSS REFERENCE

The present application claims the benefit under 35 U.S.C. § 119 of German Patent Application No. DE 102017210467.8 filed on Jun. 22, 2017, which is expressly incorporated herein by reference in its entirety.

### FIELD

The present invention relates to a hand-held power tool, including a machine housing and an interface unit.

### BACKGROUND INFORMATION

Conventional hand-held power tools may include a machine housing made of a plastic, and an interface designed to be coupleable to a rechargeable battery unit.

### SUMMARY

An object of the present invention is to improve a hand-held power tool, using simple design measures.

The object may be achieved with an example hand-held power tool in accordance with the present invention, in particular a combi drill, that includes a drive unit for transferring a working movement to an insertion tool, a machine housing that is designed in particular as a handle housing made essentially of plastic, and an interface unit that is detachably fastenable to a rechargeable battery unit, the interface unit including a retaining unit that is provided for holding the rechargeable battery unit in a fastened state connected to the hand-held power tool.

According to the present invention, the retaining unit includes metal.

The retaining unit contains or is made of metal.

In particular, the retaining unit is designed and configured in such a way that heat dissipation from the rechargeable battery unit takes place via the retaining unit.

In particular, the retaining unit may include or be made of aluminum. The retaining unit may preferably include a zinc alloy, a magnesium alloy, and/or a steel alloy.

Against the background of the continually increasing demands for reliable operation of hand-held power tools independent of the power grid, increasingly stringent requirements are also imposed on interfaces between a hand-held power tool and a rechargeable battery unit. The aim is for the rechargeable battery unit of the next generations to have higher charging capacities on the one hand, and higher current intensities on the other hand, in which, however, greater heat generation at the interface is also accompanied by greater weight of the rechargeable battery unit and thus, more demanding requirements for the design of the interface.

Heat may be dissipated in a particularly simple manner by the retaining unit according to the present invention. The heat may be conducted to the outside particularly quickly and easily due to the high heat transfer coefficient of metal.

A heat transfer coefficient of the retaining unit may be at least 50 times, preferably 100 times, more preferably 1000 times, particularly preferably 2000 times, higher than a thermal conduction coefficient of the machine housing.

In addition, a particularly stable and low-wear connection between the hand-held power tool and the rechargeable battery unit may be provided.

Furthermore, improved wear behavior may be made possible due to the use of a retaining unit made of metal.

In the present context, a “drive unit” is understood in particular to mean a unit that is provided for generating at least one drive torque and relaying it in particular to an insertion tool. The drive unit particularly advantageously includes at least one electric motor. In particular, the electric motor may be designed as an electronically commutated direct current motor or a direct current motor with brushes. The drive unit is preferably provided for driving and/or setting in motion at least one insertion tool of the hand-held power tool, for example a drill and/or a tool bit and/or a cutting blade or the like, and/or at least one tool holder, for example a chuck and/or a saw blade holder and/or a bit holder or the like. A “working movement” is understood in particular to mean a translational or rotational motion of an output shaft of the hand-held power tool that is directly or indirectly transferred to the insertion tool.

A “machine housing” is understood in particular to mean an outer housing of the hand-held power tool. The machine housing includes a handle housing that is provided for being gripped by a hand of an operator of the hand-held power tool. In particular, the machine housing may include the retaining unit which, at least in sections, forms an outer housing. The machine housing is essentially formed from or made of plastic. The machine housing may be made completely of plastic, with only the retaining unit including or being made of metal. The weight of the hand-held power tool may be reduced in this way. However, the manufacturing processes may also be reduced to a particularly great extent. In particular, the machine housing also includes an on/off switch for switching the drive unit on and off, and a gear unit that is preferably designed as a planetary gear. The gear unit may include at least two or at least three gears, at least one of which is shiftable. The planetary gear may include adjustable torque couplings that are engageable or disengageable.

The rechargeable battery unit in a fastened state may be connected to the hand-held power tool, so that there is an electrical contact of the rechargeable battery unit with the hand-held power tool, in particular the drive unit. In the process, the rechargeable battery unit is connected to the interface unit. The rechargeable battery unit is used for supplying the hand-held power tool with electrical energy. The rechargeable battery unit in a released state may be detached from the hand-held power tool, so that there is no electrical contact of the rechargeable battery unit with the hand-held power tool, in particular the drive unit. The rechargeable battery unit is preferably designed as a rechargeable battery pack.

In particular, the retaining unit may be provided for accommodating the rechargeable battery unit and holding it on the hand-held power tool. The interface unit may preferably include electrical contact elements that are provided for transmitting electrical energy from the rechargeable battery unit to the hand-held power tool, in particular the drive unit of the hand-held power tool.

The interface unit may include a mechanical interface that is provided for connecting the hand-held power tool to the rechargeable battery unit. The retaining unit may be designed as a mechanical interface of the interface unit.

The interface unit may also include an electrical interface to electrical contact elements that are provided for delivering electrical energy to the hand-held power tool.

The interface unit is in particular designed as a rechargeable battery interface and is provided for accommodating a rechargeable battery unit. The rechargeable battery unit is replaceably connectable to the interface unit, so that the rechargeable battery unit may be removed from the hand-held power tool or reused as needed. The rechargeable battery unit may include a mechanical interface that is provided for being coupled to the mechanical interface of the interface unit.

The interface unit and/or the rechargeable battery unit may include a locking device, in particular a detent, which is provided for locking the rechargeable battery unit to the hand-held power tool, in particular to the interface unit. Alternatively or additionally, the interface unit and/or the rechargeable battery unit may also include some other device, which appears meaningful to those skilled in the art, for retaining and/or for locking the interface unit to the hand-held power tool. Such devices are conventional.

The retaining unit in a fastened state may directly contact the rechargeable battery unit, so that the heat generated in the rechargeable battery unit may be transferred or discharged to the retaining unit. Trapped heat, which in conventional hand-held power tools arises in an interface between the hand-held power tool and the rechargeable battery unit due to the fact that with conventional interfaces no heat dissipation is provided, may thus be reduced or dissipated.

Advantageous refinements of the hand-held power tool according to the present invention are described herein.

It may be advantageous for the retaining unit to delimit the hand-held power tool. The retaining unit in a released state may form a base area of the hand-held power tool which comes into contact with a substrate and forms a standing surface, for example when the hand-held power tool is set down. The retaining unit in a fastened state may be situated, at least essentially in sections, between the hand-held power tool and the rechargeable battery unit. In particular, the retaining unit, at least in sections, may enclose the hand-held power tool, in particular the electrical interface of the hand-held power tool, and also the rechargeable battery unit, at least in sections. Heat that arises from the rechargeable battery unit may thus be prevented from being transferred to the hand-held power tool, in particular an electronics unit, by heat being released to the surroundings with the aid of convection or radiation, for example. In addition, the metallic retaining unit may form an impact protector for the hand-held power tool (if the hand-held power tool is dropped), so that damage to the retaining unit or to the mechanical interface is minimized, or unintentional detachment of the rechargeable battery unit from the hand-held power tool is avoided.

By use of a retaining unit made of metal, a center of gravity of the hand-held power tool may be displaced in the direction of the interface unit or the rechargeable battery unit, so that stability as well as balance of the hand-held power tool, in particular for nonhorizontal substrate surfaces, are increased.

Furthermore, it may be advantageous for the hand-held power tool to include an electronics unit that is situated directly adjacent to the retaining unit. In particular, the retaining unit may be situated directly below the electronics unit. The retaining unit may preferably be situated between the electronics unit and the rechargeable battery unit. The electronics unit may include a control and/or regulation unit. The electronics unit may be provided for controlling and/or regulating the drive unit. The electronics unit may be situated on a side of the hand-held power tool, in particular of the handle housing, facing away from the drive unit. The retaining unit may enclose the electronics unit in a plane of 270°. The heat from the electronics unit may thus be dissipated in a particularly reliable manner with the aid of the retaining unit. An “electronics unit” is understood to mean a control and/or regulation unit that includes in particular a unit with a processor unit and with a memory unit, and preferably with an operating program that is stored in the memory unit.

Moreover, it may be advantageous for the hand-held power tool, in particular the interface unit, to include a contact device, in particular a contact plate that is connected to the retaining unit and/or the electronics unit. In particular, the contact device may contact the retaining unit. The contact device may preferably contact the electronics unit. The contact device may preferably be designed, at least in part, as a heat conduction element that is provided for dissipating heat from the rechargeable battery unit and/or the electronics unit to the retaining unit. The contact device may thus be cooled by the retaining unit. The contact device may be enclosed by the retaining unit. In one alternative specific embodiment, the contact device may be spaced apart from the retaining unit. The contact device may form the electrical interface.

The rechargeable battery unit, the drive unit, the on/off switch, and the contact device are electrically connected with the aid of lines.

In addition, it may be advantageous for the retaining unit to adjoin the machine housing and to form, at least in part, an outer housing of the hand-held power tool. The machine housing may be situated in flush alignment with the retaining unit. The retaining unit may have an outer surface that is situated essentially in flush alignment with an outer surface of the machine housing. The machine housing is made at least essentially of a plastic, and preferably includes two components (soft and hard components) or also three or four components. The machine housing may preferably be formed with the aid of a shell construction.

Furthermore, it may be advantageous for the retaining unit to have a one-piece or at least a two-piece design.

Moreover, it may be advantageous for the retaining unit to have a U-shaped design. In particular, the retaining unit may essentially enclose the electrical interface, thus avoiding damage to the electrical interface if the hand-held power tool drops. In particular, the interface unit, in particular the contact device, includes electrical contact elements that are enclosed by the retaining unit, in particular on at least three sides. The contact device preferably forms the electrical interface of the interface unit.

As a result, the operator of the hand-held power tool may unambiguously and intuitively recognize an insertion direction of the rechargeable battery unit for connecting the rechargeable battery unit to the hand-held power tool. The retaining unit may thus form a preferably large outer surface for dissipating heat in a particularly effective manner.

It is provided that the retaining unit is designed as a reinforcement unit. In particular, the machine housing may include at least two housing shells that are connected with the aid of the retaining unit. The retaining unit may connect the at least two housing shells to one another, in that the two housing shells are fastened to the retaining unit. In particular, the housing shells may be fastened with the aid of at least one fastening means. The retaining unit may be situated on the hand-held power tool in such a way that the retaining unit connects the two housing shells to one another, in particular in a form-fit manner. The retaining unit may be connected to the first housing shell and to the second housing shell, in particular with the aid of a screw connection. Alternatively or additionally, however, other connections of the two housing shells may also be considered. Fastening means such as a fastening screw and corresponding recesses for accommodating the fastening means in the machine housing of the hand-held power tool may thus be dispensed with. In this way, the rechargeable battery unit may be securely held on the hand-held power tool, even in the event of an impact.

It is also provided that the retaining unit includes a guide unit with a guide element which extends along a sliding plane that is situated transversely with respect to a longitudinal extension of the handle housing and which is provided for accommodating the rechargeable battery unit along the sliding plane. It is understood that the guide unit may also include two or more guide elements. The guide element may be designed as a guide track. The rechargeable battery unit may preferably be held in the guide unit in a form-fit manner, and may be secured against falling out with the aid of a detent connection, for example. In particular, an overlap of the rechargeable battery unit with the hand-held power tool with respect to a rechargeable battery unit for insertion into the hand-held power tool, in particular into the handle housing, may be minimized. The rechargeable battery unit may thus be situated preferably far toward the outside in order to dissipate heat to the surroundings in a particularly effective manner.

It is also provided that the retaining unit includes at least two oppositely situated guide elements. The guide elements may be spaced apart from one another. The guide elements may be separate from one another. The guide elements may be connected to one another via a connecting web. The guide elements may be situated in parallel to one another. The guide elements may delimit the contact device of the interface unit. The guide elements may in each case have a fixed end and a free end facing away from the fixed end. The fixed end may be connected in one piece to the connecting web.

It may be advantageous for the, in particular each, guide element to be designed as a guide recess. In particular, the guide recess may include a guide elevation with a positioning surface that is provided for positioning the rechargeable battery unit with respect to the interface unit. In particular, a guide element may include at least two guide elevations. A guide element may preferably have at least two positioning surfaces that are spaced apart from one another. The at least two positioning surfaces may be situated in parallel to one another and spaced apart from one another in the orthogonal direction. The guide recesses may be situated opposite one another. The guide recesses may have a mutually exposed design. The guide recesses may delimit a mechanical interface of the rechargeable battery unit. The guide recesses may have a mirror-symmetrical design. The, in particular each, guide recess may include a limit stop, on a side of the retaining unit associated with the connecting web, that is provided for delimiting an insertion operation of the rechargeable battery unit. Alternatively, the guide recesses may be situated separate from one another, so that they are not connected to one another with the aid of a connecting web. The guide elements may have a rod-shaped design.

The guide elevation may be provided for reducing a distance of the rechargeable battery unit from the hand-held power tool, in particular the retaining unit. The guide elevation may have a ramp surface that is situated transversely with respect to the positioning surface and is provided for lifting the rechargeable battery unit from the released state into the fastened state during an insertion operation, so that the rechargeable battery unit in a fastened state rests on the positioning surface. The guide elevation may protrude into the guide recess and delimit same.

The rechargeable battery unit may include a rechargeable battery guide unit with a shape that is complementary to the guide unit of the retaining unit. The rechargeable battery guide unit may include at least one guide track, which is provided for establishing a form-fit connection to the guide recess. The rechargeable battery guide unit may preferably be made of plastic. The rechargeable battery guide unit may have at least one rechargeable battery guide surface that is provided for moving along the at least one positioning surface during an insertion operation. The at least one rechargeable battery guide surface may, at least in sections, form a countersurface to the at least one positioning surface.

The at least one positioning surface may have a design with play with respect to the rechargeable battery unit, so that a play of up to 0.2 mm, in particular up to 0.5 mm, is made possible. Secure assembly and disassembly may thus be possible, even in the event of soiling.

Moreover, the present invention relates to a hand-held power tool system that includes a hand-held power tool, in particular a combi drill, and a rechargeable battery unit that is provided for supplying power and that is detachably connectable to the hand-held power tool.

### BRIEF DESCRIPTION OF THE DRAWINGS

Further advantages result from the following description of the figures. Exemplary embodiments of the present invention are illustrated in the figures. The figures and the description herein contain numerous features in combination. Those skilled in the art will also advantageously consider the features individually and combine them into further meaningful combinations.

FIG. 1 shows a view of a hand-held power tool according to the present invention together with a rechargeable battery unit.

FIG. 2 shows a section of the hand-held power tool from FIG. 1.

FIG. 3 shows a perspective exploded view of the hand-held power tool together with the rechargeable battery unit.

FIG. 4 shows a perspective view of a retaining unit.

Identical components are provided with the same reference numerals in the following figures.

### DETAILED DESCRIPTION OF EXAMPLE EMBODIMENTS

The figures each relate to a hand-held power tool 101 with a holding unit 103 for holding insertion tools (not shown) such as screwdriver bits for screwing in screws, or drills for drilling holes into a workpiece. Holding unit 103 includes a clamping device 105, known to those skilled in the art, which is provided for holding an insertion tool in hand-held power tool 101.

Hand-held power tool 101 is in particular designed as a combi drill.

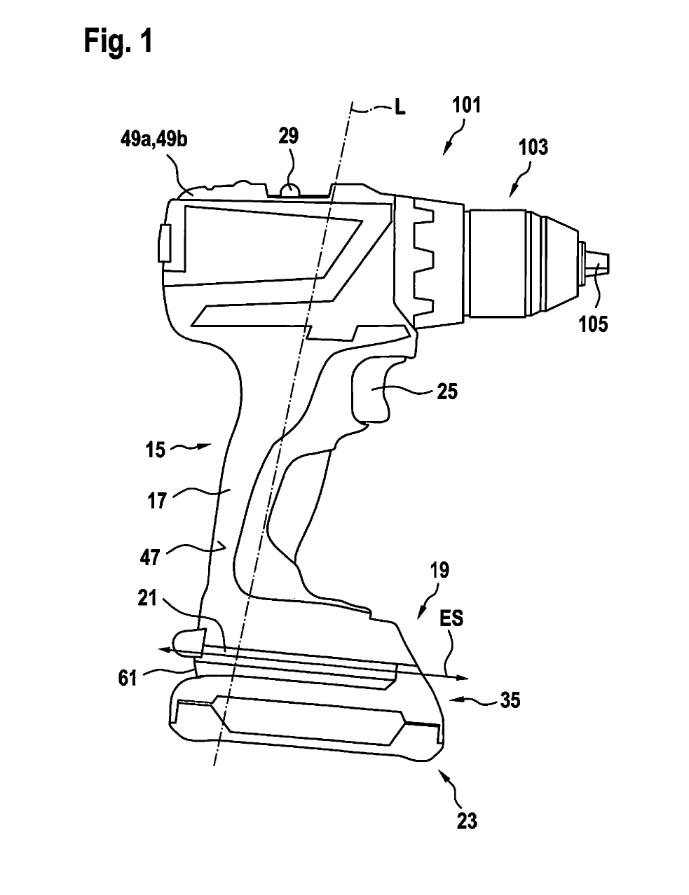

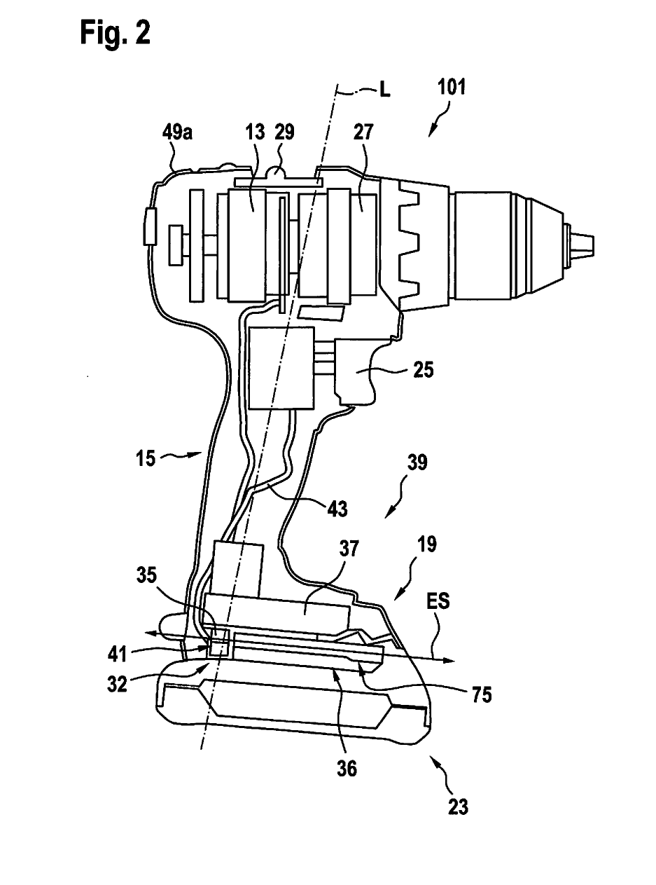

FIG. 1 shows hand-held power tool 101, with a drive unit 13 (FIG. 2) for transferring a working movement to an insertion tool. Drive unit 13 includes at least one electric motor 13 that is designed as an electronically commutated direct current motor.

Hand-held power tool 101 includes a machine housing 15 which is designed as a handle housing 15 and which forms an outer housing 17 of hand-held power tool 101. Handle housing 15 is provided for being gripped by a hand of an operator of hand-held power tool 101.

Hand-held power tool 101 also includes an interface unit 19 with a retaining unit 21 that is detachably fastenable to a rechargeable battery unit 23. Retaining unit 21 is provided for holding rechargeable battery unit 23 in a fastened state connected to hand-held power tool 101.

Machine housing 15 also includes an on/off switch 25 for switching drive unit 13 on and off, and a gear unit 27 that is designed as a planetary gear 27. Gear unit 27 includes at least two gears that are shiftable with the aid of a switch button 29. In addition, planetary gear 27 includes adjustable torque couplings (not shown) that are engageable or disengageable.

Machine housing 15 also includes a retaining unit 21 which, at least in sections, forms an outer housing 17. Machine housing 15 is essentially made of plastic. Machine housing 15 is formed with the aid of a shell construction. Retaining unit 21 delimits hand-held power tool 101 from a side of the handle housing facing away from drive unit 13. Retaining unit 21 is made of metal. Retaining unit 21 is designed as a retaining clamp 21.

Retaining clamp 21 is designed and situated in such a way that heat dissipation from the rechargeable battery unit 23 takes place via retaining clamp 21.

Rechargeable battery unit 23 in a fastened state is connected to hand-held power tool 101, so that there is an electrical contact of rechargeable battery unit 23 with drive unit 13 of hand-held power tool 101, rechargeable battery unit 23 being connected to interface unit 19. Rechargeable battery unit 23 supplies hand-held power tool 101 with electrical energy.

Rechargeable battery unit 23 in a released state is separate from hand-held power tool 101, so that there is no electrical contact of rechargeable battery unit 23 with drive unit 13 of hand-held power tool 101. Rechargeable battery unit 23 is designed as a rechargeable battery pack 23.

Interface unit 19 includes a mechanical interface that is provided for connecting hand-held power tool 101 to rechargeable battery pack 23. Retaining clamp 21 is designed as a mechanical interface of interface unit 19, and is provided for accommodating rechargeable battery pack 23 and holding it on interface unit 19.

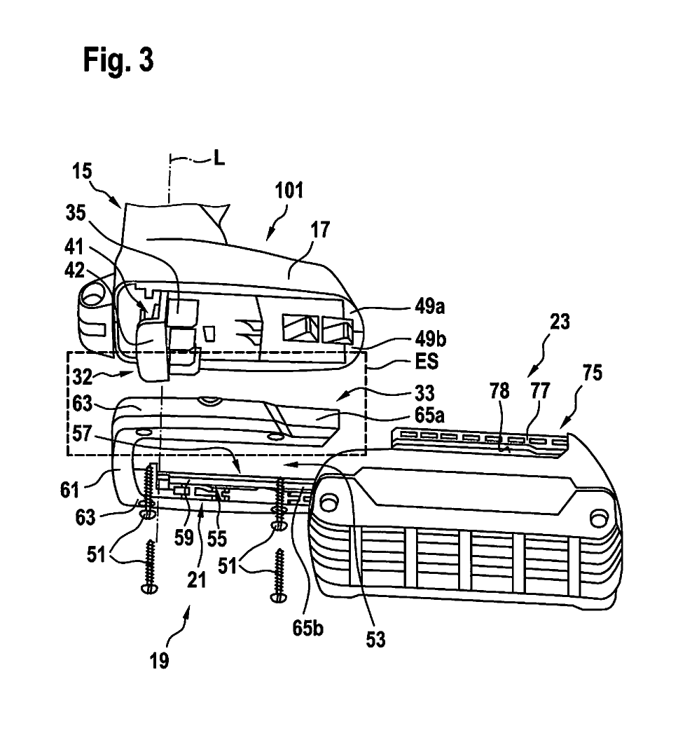

Interface unit 19 may also include an electrical interface 32 (FIG. 3) with a contact device 42, which includes electrical contact elements 35 that are provided for delivering electrical energy to hand-held power tool 101.

Rechargeable battery unit 23 includes a mechanical interface 33 that is provided for being coupled to mechanical interface 33 of interface unit 19.

Interface unit 19 and/or rechargeable battery pack 23 include(s) a detent 35 that is provided for holding rechargeable battery pack 23 on interface unit 19.

Retaining clamp 21 in a fastened state contacts rechargeable battery pack 23 directly, so that the heat that is generated in rechargeable battery pack 23 is transferred or dissipated to retaining clamp 21 in order to reduce or dissipate trapped heat in interface unit 19. Retaining clamp 21 delimits hand-held power tool 101. Retaining clamp 21 in a fastened state is situated, at least essentially in sections, in hand-held power tool 101 and rechargeable battery pack 23. Retaining clamp 21 encloses, at least in sections, electrical interface 32 of hand-held power tool 101 and encloses, at least in sections, rechargeable battery pack 23.

Hand-held power tool 101 includes an electronics unit 37 that is situated directly adjacent to retaining clamp 21. Retaining clamp 21 is situated directly below electronics unit 37. Retaining clamp 21 is situated between electronics unit 37 and rechargeable battery pack 23. Electronics unit 37 includes a control and/or regulation unit that is provided for controlling and/or regulating drive unit 13. Electronics unit 37 is situated on a side 39 of handle housing 15 facing away from drive unit 13. Retaining clamp 21 may enclose electronics unit 37 in a plane of up to approximately 270°.

Interface unit 19 includes a contact device 41 that is connected to retaining clamp 21 and/or electronics unit 37. Contact device 41 may form electrical interface 32. Contact device 41 also includes a contact plate 42 that contacts retaining clamp 21. In one alternative specific embodiment, contact plate 42 is spaced apart from retaining clamp 21. Contact plate 42 contacts electronics unit 37. Contact plate 42 is designed at least in part as a heat conduction element that is provided for dissipating heat from rechargeable battery pack 23 and/or electronics unit 37 to retaining clamp 21, as the result of which contact plate 42 is cooled by retaining clamp 21. Contact plate 42 may be enclosed by retaining clamp 21.

Rechargeable battery pack 23, drive unit 13, on/off switch 25, and contact plate 42 are electrically connected with the aid of lines 43.

Retaining clamp 21 adjoins machine housing 15 and forms, at least in part, an outer housing 17 of hand-held power tool 101. Machine housing 15 is situated in flush alignment with retaining clamp 21. Retaining clamp 21 has an outer surface 45 that is situated essentially in flush alignment with an outer surface 47 of machine housing 15. Retaining clamp 21 has a one-piece design.

Retaining clamp 21 has a U-shaped design. Retaining clamp 21 essentially encloses contact plate 42, thus avoiding damage to the contact plate if hand-held power tool 101 drops. Contact device 41 includes electrical contact elements 35 that are enclosed by retaining clamp 21, in particular on at least three sides.

Retaining clamp 21 is designed as a reinforcement unit. Machine housing 15 includes at least two housing shells 49a, 49b that are connected with the aid of retaining clamp 21. Retaining clamp 21 connects the at least two housing shells 49a, 49b to one another, in that retaining clamp 21 is fastened to the two housing shells 49a, 49b. Housing shells 49a, 49b are fastened with the aid of four fastening means 51 designed as fastening screws 51. In one alternative specific embodiment, retaining clamp 21 may be situated on hand-held power tool 101 in such a way that retaining unit 21 connects the two housing shells 49a, 49b to one another, in particular in a form-fit manner.

Retaining clamp 21 includes a guide unit 53 with two guide elements 55a, 55b which extend along a sliding plane ES that is situated transversely with respect to a longitudinal extension L of handle housing 15, and which are provided for accommodating rechargeable battery pack 23 along sliding plane ES. Guide elements 55a, 55b include guide tracks 57. Guide elements 55a, 55b include guide recesses 59. Guide recesses 59 are delimited at least by guide tracks 57.

Rechargeable battery pack 23 is held in guide unit 53 in a form-fit manner, and with the aid of a detent connection is secured against falling out.

Guide recesses 59 are provided as mutually opposite guide recesses 59. Guide recesses 59 are spaced apart from one another. Guide recesses 59 are separate from one another. Guide recesses 59 are connected to one another via a connecting web 61. Guide recesses 59 are situated in parallel to one another. Guide recesses 59 enclose contact plate 42 of interface unit 19. Guide recesses 59 each have a fixed end 63 and a free end 65a, 65b facing away from fixed end 63. Fixed end 65 is joined in one piece to connecting web 61.

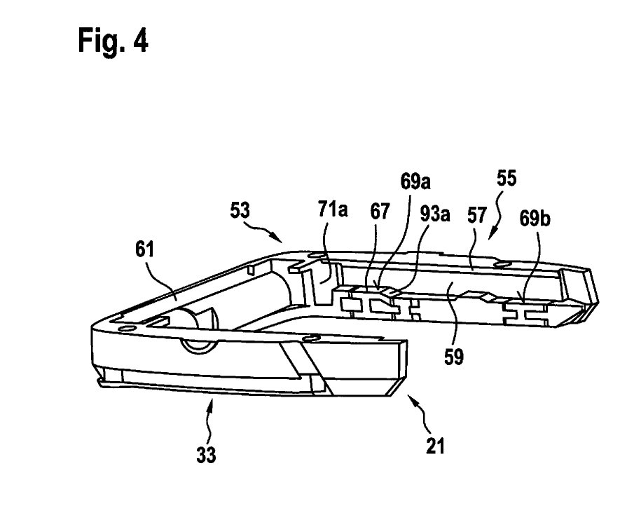

Guide recesses 59 each include a guide elevation 67 (FIG. 4), each with a positioning surface 69a that is provided for positioning rechargeable battery pack 23 with respect to interface unit 19. Each guide recess 59 has two positioning surfaces 69a, 69b that are spaced apart from one another. The two positioning surfaces 69a, 69b are situated in parallel to one another, and spaced apart from one another in the orthogonal direction. Guide recesses 59 are situated opposite one another. Guide recesses 59 have a mutually exposed design. Guide recesses 59 delimit a mechanical interface 33 (FIG. 4) of rechargeable battery pack 23. Guide recesses 59 have a mirror-symmetrical design. Guide recesses 59 each include a limit stop 71a, on a side of retaining clamp 21 associated with connecting web 61, which is provided for delimiting an insertion operation of rechargeable battery unit 23.

In one alternative specific embodiment, guide recesses 59 are situated separate from one another, so that they are not connected to one another with the aid of a connecting web 61.

Guide recesses 59 have a rod-shaped design.

Guide elevations 67 are provided for reducing a distance of rechargeable battery pack 23 from hand-held power tool 101. Guide elevations 67 have a ramp surface 93a that is situated transversely with respect to positioning surface 69a and is provided for lifting rechargeable battery pack 23 from the released state into the fastened state during an insertion operation, so that rechargeable battery pack 23 in a fastened state rests on positioning surface 69a. Guide elevation 67 protrudes into guide recess 59 and delimits same.

Rechargeable battery pack 23 includes a rechargeable battery guide unit 75 with a shape that is complementary to guide unit 53 of retaining clamp 21. Rechargeable battery guide unit 75 includes at least one guide track 77, which is provided for establishing a form-fit connection to guide recess 59. Rechargeable battery guide unit 75 is made of plastic. Rechargeable battery guide unit 75 has at least one rechargeable battery guide surface 77 that is provided for moving along positioning surfaces 69 during an insertion operation. The at least one rechargeable battery guide surface 77 may, at least in sections, form a countersurface to positioning surfaces 69.

Positioning surfaces 69 have a design with play with respect to rechargeable battery pack 23, so that a play of up to 0.2 mm, in particular up to 0.5 mm, is made possible, thus enabling secure assembly and disassembly.

What is claimed is:

1. A hand-held power tool, comprising:
a drive unit for transferring a working movement to an insertion tool;
a machine housing that is designed as a handle housing made of plastic; and
an interface unit that is detachably fastenable to a rechargeable battery unit, the interface unit including a retaining unit provided for holding the rechargeable battery unit in a fastened state connected to the hand-held power tool;
wherein the retaining unit includes metal.

2. The hand-held power tool as recited in claim 1, wherein the hand-held power tool is a combi drill.

3. The hand-held power tool as recited in claim 1, wherein the retaining unit delimits the hand-held power tool.

4. The hand-held power tool as recited in claim 1, further comprising:
an electronics unit situated directly adjacent to the retaining unit.

5. The hand-held power tool as recited in claim 4, wherein the interface unit includes a contact plate that is connected to at least one of the retaining unit and the electronics unit.

6. The hand-held power tool as recited in claim 1, wherein the retaining unit adjoins the machine housing and forms, at least in part, an outer housing of the hand-held power tool.

7. The hand-held power tool as recited in claim 1, wherein the retaining unit has a one-piece design.

8. The hand-held power tool as recited in claim 1, wherein the retaining unit has an at least two-piece design.

9. The hand-held power tool as recited in claim 1, wherein the retaining unit has a U-shaped design.

10. The hand-held power tool as recited in claim 1, wherein the retaining unit is designed as a reinforcement unit, the machine housing including at least two housing shells that are connected with the aid of the retaining unit and fastened with the aid of at least one fastener.

11. The hand-held power tool as recited in claim 1, wherein the retaining unit includes a guide unit with a guide element which extends along a sliding plane that is situated transversely with respect to a longitudinal extension of the handle housing and which is provided for accommodating the rechargeable battery unit along the sliding plane.

12. The hand-held power tool as recited in claim 1, wherein the retaining unit includes at least two mutually opposite guide elements that are spaced apart from one another.

13. The hand-held power tool as recited in claim 12, wherein each of the guide elements is designed as a guide recess, the guide recess including a guide elevation with a positioning surface that is provided for positioning the rechargeable battery unit with respect to the interface unit.
